(19) United States
(12) Patent Application Publication
(10) Pub. No.: US 2006/0028431 A1
(43) Pub. Date: Feb. 9, 2006

(54) Remote control system

(76) Inventor: Hou-Tin Leong, Sanchong City (TW)

Correspondence Address: SNELL & WILMER;ONE ARIZONA CENTER, 400 EAST VAN BUREN, PHOENIX, AZ, 850040001, US

(21) Appl. No.: 11/169,454

(22) Filed: Jun. 29, 2005

(30) Foreign Application Priority Data
Jun. 29, 2004 (TW) 93119011

(51) Int. Cl. G09G 5/00

(52) U.S. Cl. 345/156

(57) ABSTRACT

A remote control system including a mobile unit and a remote device. The mobile unit stores first data and has a first processor. The remote device stores second data and is wireless-connected to the mobile unit for receiving the first data. The remote device has a random number generator and a second processor. The random number generator provides a random number. The random number is sent to the mobile unit when the first data correspond to the second data. The second processor, coupled to the random number generator, generates a second code based on at least the random number. The first processor generates a first code based on at least the random number and sends the first code to the remote device. The remote device is activated when the first code corresponds to the second code.

### CROSS-REFERENCE TO RELATED APPLICATIONS

This application claims the right of priority based on Taiwan Patent Application No. 093119011 entitled “Remote Control System,” filed on Jun. 29, 2004, which is incorporated herein by reference and assigned to the assignee herein.

### FIELD OF INVENTION

The present invention relates to a remote control system and a remote control method.

### BACKGROUND OF THE INVENTION

Conventional mechanical type security devices, such as cylindrical locks, typically require specific physical keys to operate. The physical key is inconvenient to manage and is easy to copy by others. In light of these drawbacks, current electronic security systems enhance the reliability by using the “password.” Moreover, it is convenient for a wireless module of a remote control system to input the password. However, the password authentication process is a “one way” process, and the password is susceptible of being intercepted during the wireless communication.

In addition to the basic entrance security system, more and more security authentications are needed in daily scenes, e.g., the financial transactions. Therefore the security of the current wireless control system needs further improvement.

On the other hand, mobile units such as mobile phones, laptops, and PDAs are widespread in recent years. And mobile phones further become necessary articles to people.

Therefore, with the built-in processor, memory, and wireless communication module, it will be advantageous to incorporate a mobile phone in a remote control system.

### SUMMARY OF THE INVENTION

The main aspect of the present invention is to provide a remote control system, a mobile unit, and a remote control method.

Another aspect of the present invention is to provide a remote control system and a remote control method with function of security authentication.

Still another aspect of the present invention is to provide a security authentication system and a security authentication method with the wireless communication.

Further another aspect of the present invention is to provide a security authentication system and a security authentication method using the wireless communication and the mobile unit.

The present invention resides in that the mobile unit replaces the conventional physical key and a “two ways” authentication process between the mobile unit and the remote device is involved. In addition, an algorithm and a random number for the algorithm are utilized in one embodiment of the present invention. The security is improved because the algorithm is predetermined in the mobile unit and the remote device as well and is unable to be intercepted via the wireless communication.

In one embodiment, a remote control system includes a mobile unit and a remote device. The mobile unit stores first data and has a first processor. The remote device stores second data and is wireless-connected to the mobile unit for receiving the first data. The remote device has a random number generator and a second processor. The random number generator provides a random number. The random number is sent to the mobile unit when the first data correspond to the second data according to a first manner. The second processor, coupled to the random number generator, generates a second code based on at least the random number. The first processor generates a first code based on at least the random number and sends the first code to the remote device. The remote device is activated when the first code corresponds to the second code according to a second manner.

Also disclosed is a remote control method for a remote control system. The remote control system includes a mobile unit and a remote device. The mobile unit stores first data and the remote device stores second data. The method includes: (a) wireless-connecting the mobile unit and the remote device; (b) sending the first data to the remote device; (c) comparing the first data with the second data; (d) generating and sending, by the remote device, a random number to the mobile unit when the first data correspond to the second data according to a first manner; (e) generating, by the mobile unit, a first code based on the random number and sending the first code to the remote device, the remote device generating a second code based on the random number; (f) comparing the second code with the first code; and (g) activating the remote device when the first code corresponds to the second code according to a second manner.

The foregoing and other features of the invention will be apparent from the following more particular description of embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1 is an illustration of an embodiment of the present invention;

FIG. 2 is an illustration of a remote control process according to an embodiment of the present invention; and

FIG. 3 is a flowchart of a remote control method according to an embodiment of the present invention.

### DETAILED DESCRIPTION

The present invention provides a remote control system including a mobile unit and a remote device. The remote device, wireless-connected to the mobile unit, executes a remote control method to determine whether to accept the control signal from the mobile unit. The mobile unit can be a mobile phone, a PDA, a digital camera, a laptop computer, a watch, and other mobile unit capable of performing wireless communication. The remote device is connected to a functional system, such as a car, an entrance security system, an automatic teller machine (ATM), etc. Activated by the control signal from the mobile unit, the remote device is used to enable the functional system, e.g., start the car, turn on the entrance security system, or perform an electronic transaction on the ATM.

In one embodiment, the wireless communication between the mobile unit and the remote device uses the well-known wireless communication technology, such as GSM or PHS. Therefore, existing mobile communication modules can be applied to the remote control system of the present invention. The wireless communication of the present invention also can utilize other wireless communication protocols such as infra-red, bluetooth, or IEEE 802.11 protocols. Also, the wireless communication of the present invention is not limited to the digital signals or analog signals. In another embodiment, the wireless communication of the present invention is a “point to point” type, without additional devices for the signal relay. Therefore the mobile unit and the remote device are connected within a limited distance which varies with the different wireless communications or different demanded services.

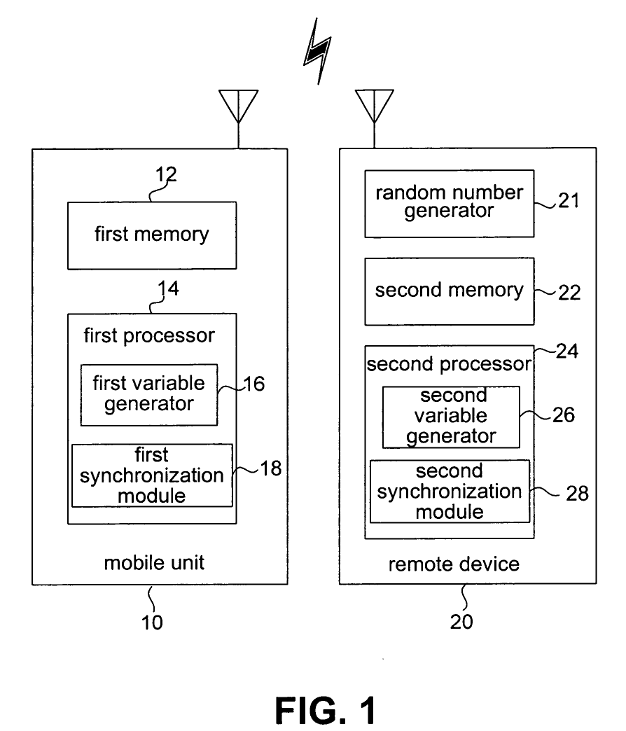

Referring to FIG. 1, an exemplary remote control system includes a mobile unit 10 and a remote device 20. The mobile unit 10 has a first memory 12 for storing first data and has a first processor 14 for performing an algorithm. The remote device 20 has a second memory 22 for storing second data, and also has a second processor 24 for performing an algorithm and a random number generator 21 for providing a random number. The first processor 14 and the second processor 24 can be CPU, or electronic circuits for performing a specific algorithm. The algorithm for the present invention can be an A3 algorithm generally used in GSM system or other suitable algorithms.

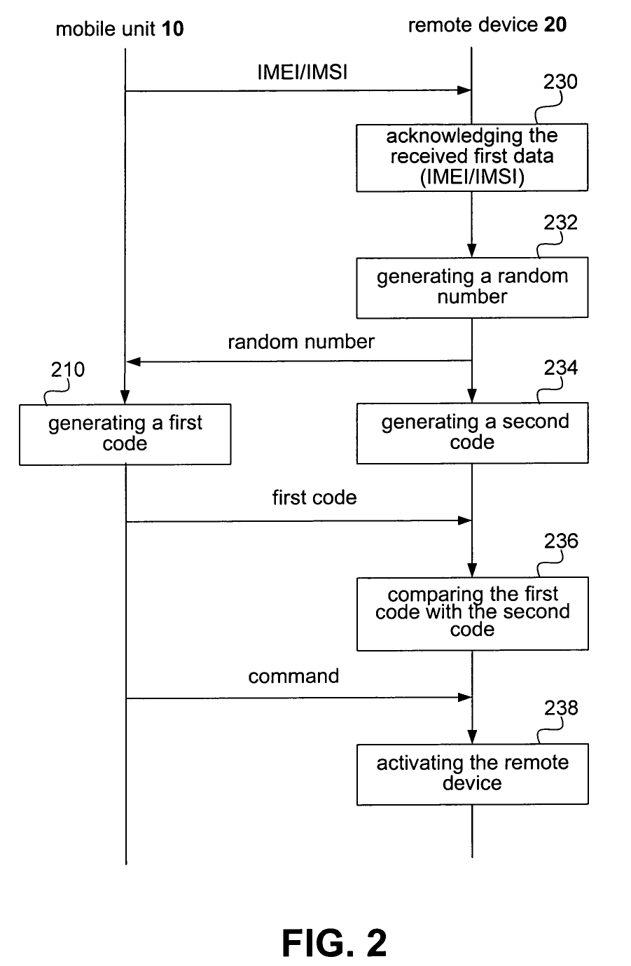

Now referring to FIG. 2, the first data of the mobile unit 10 can be an International Mobile Equipment Identity (IMEI) code and/or an International Mobile Subscriber Identity (IMSI) code. The mobile unit 10 sends the first data to the remote device 20. The second data in the remote device 20 is predetermined to correspond to the first data from the mobile unit 10 according to a first manner. Therefore, when the remote device 20 acknowledges that its second data corresponds to the received first data according to the first manner (step 230), the random number generator 21 generates a random number, ranged from 0 to (2¹²⁸−1) (step 232). The remote device 20 sends the generated random number to the mobile unit 10, and then the first processor 14 performs the algorithm to generate a first code based on the received random number (step 210). Meanwhile, the second processor 24 performs the algorithm to generate a second code based on the random number (step 234). After that, the mobile unit 10 sends the first code to the remote device 20. If the remote device 20 acknowledges that its second code corresponds to the received first code according to a second manner (step 236), the remote device 20 activates according to the command from the mobile unit 10 (step 238). In another embodiment, the first processor 14 generates the first code further based on the first data (in step 210), and the second processor 24 generates the second code further based on the second data (in step 234). In addition, the first memory 12 and the second memory 22 can be magnetic disks, optical disks, flash memories, or internal/external electronic circuits or chips with built-in data.

Typically, a mobile phone has an International Mobile Equipment Identity (IMEI) code, which is built-in by the phone manufacturer. In addition, for each phone number, the telephone company will assign an International Mobile Subscriber Identity (IMSI) code. The IMSI code can be built in the mobile phone or stored in a Subscriber Identity Module (SIM) card to be inserted into the mobile phone. In an embodiment, the mobile unit 10 is a mobile phone and takes IMEI code and/or IMSI code as the first data. In one embodiment, the first manner is decided as “equal,” and the remote device 20 also stores the same IMEI code and/or IMSI code as the second data.

The first processor 14 further includes a first variable generator 16 for generating a first variable, and the second processor 24 further includes a second variable generator 26 for generating a second variable. In addition, the first processor 14 has a first synchronization module 18, and the second processor 24 has a second synchronization module 28. The first synchronization module 18 and the second synchronization module 28 are synchronized so that the first variable corresponds to the second variable according to a third manner. For example, the first variable generator 16 and the second variable generator 26 have the same variable table outputting variables according to time. If the variable table has values of “2, 4, 8, 16, . . . ”, then the first variable generator 16 and the second variable generator 26 would output “2, 4, 8, 16, . . . ” every T unit of time interval in sequence. When the first synchronization module 18 synchronizes with the second synchronization module 28, the first variable generator 16 and the second variable generator 26 respectively output the variables in the same timing sequence, whereby the value of the first variable corresponds to the value of the second variable according to a third manner. In the example above, the third manner is “if the first and the second variable are equal.” More specifically, the first synchronization module 18 and the second synchronization module 28 respectively have a timer. At different times, the first variable generator 16 outputs different values for the first variable, and the second variable generator 26 outputs different values for the second variable. After synchronization of the first synchronization module 18 with the second synchronization module 28, at each time point, the value of the first variable corresponds to the value of the second variable according to the third manner. In one embodiment, the first processor 14 performs the algorithm to generate the first code further based on the value of the first variable, the random number, and the first data, and the second processor 24 performs the algorithm to generate the second code further based on the value of the second variable, the random number, and the second data. Similarly, when the first code corresponds to the second code according to the second manner, the remote device 20 receives and follows the command issued from the mobile unit 10.

It should be noted that the aforementioned first manner, second manner, and third manner can be other ways in addition to “equal,” such as “a specific difference,” “a specific ratio,” or “a specific multiple,” “a reference table” or “a function.” For the aforementioned example, when IMEI/IMSI codes are taken as the first data and the second data, the first manner is “equal,” wherein the first data is equal to the second data. In one embodiment, as “a reference table” applies to the first manner, the corresponding relation between the first data and the second data is regulated by the predetermined reference. In another embodiment, if “a square function” applies to the second manner, then the second code is required to be equal to the square of the first code. In a further embodiment, if “ratio of 10” applies to the third manner, then the value of the first variable is required to be 10 times the value of the second variable. Also note that the first code is generated at least based on the random number provided to the first processor 14, and the second code is generated at least based on the random number provided to the second processor 24, so that the algorithms performed by the first processor 14 and the second processor 24 will effect the relations among the first manner, the second manner, and the third manner. The selection of the first manner, the second manner, and the third manner is not random, but should be known to one skilled in the art to embody the present invention.

In an embodiment wherein the mobile unit 10 is a mobile phone, the mobile unit 10 communicates with the remote device 20 via the operation frequency band, and the mobile unit 10 needs no additional module or antenna. The mobile unit 10 and the remote device 20 pre-select a first frequency and a second frequency, and alternatively use the first frequency or the second frequency for communication. When the first frequency is not available, e.g., too much interference, the second frequency will be the substitute. In addition, the communication between the mobile unit 10 and the remote device 20 is a “point to point” type, wherein the communication distance is limited. With the antenna and the battery of a conventional mobile phone, the communication distance is similar to the effective range of a home cordless phone set and is enough for the common entrance security system.

In one embodiment, the remote device 20 is connected to a car, and a user uses the mobile unit 10 to wireless-connect the remote device 20. When the remote device 20 is activated, the user can use the mobile unit 10 to send a command to the remote device 20 to, for example, lock/unlock the car or start the engine. In another embodiment, the remote device 20 is connected to an ATM, and the user uses the mobile unit 10 to wireless-connect the remote device 20. When the remote device 20 is activated, the user uses the mobile unit 10 to send a command to the remote device 20 to perform an electronic transaction. Those skilled in the art should know that, within the scope of the invention, the remote device 20 can be connected to an entrance security system or many other devices.

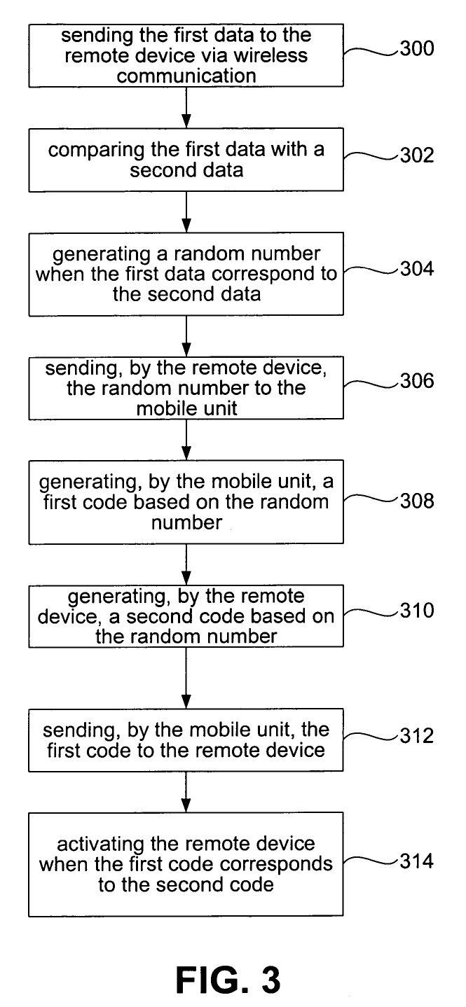

With reference to the mobile unit 10 and the remote system 20 in FIG. 1, FIG. 3 is a flowchart of a method according to an embodiment of the present invention. It begins with the step 300 sending the first data to the remote device 20 via wireless communication. Then in the step 302, the remote device 20 compares the first data with the second data. The step 304 is to generate, by the remote device, a random number when the first data correspond to the second data according to the first manner. Next, it turns to the step 306 sending the random number to the mobile unit 10. After the random number is received, the step 308 is to generate, by the mobile unit 10, a first code based on the random number. In the step 310, the remote device 20 generates a second code based on its random number. Next, in the step 312, the mobile unit 10 sends the first code to the remote device 20. Later, the step 314 is to activate the remote device when the first code corresponds to the second code according to the second manner. In another embodiment, the mobile unit 10 further provides a first variable, and the remote device 20 further provides a second variable. The mobile unit 10 and the remote device 20 are synchronized so that the first variable corresponds to the second variable according to the third manner. In the step 308, the mobile unit 10 generates the first code further based on the value of the first variable, the random number, and the first data. In the step 310, the remote device 20 generates the second code further based on the value of the second variable, the random number, and the second data.

The flowchart in FIG. 3 describes specific operations occurring in a particular order. In alternative implementations, certain of the steps may be performed in a different order, modified or removed. Moreover, steps may be added to the above described operations and still conform to the described implementations. Further, operations described herein may occur sequentially or certain operations may be processed in parallel.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A remote control system, comprising:
a mobile unit storing first data and comprising a first processor;
a remote device storing second data and wireless-connected to said mobile unit for receiving said first data, said remote device comprising:
a random number generator for providing a random number, said random number being sent to said mobile unit when said first data correspond to said second data according to a first manner, wherein said first processor generates a first code based on at least said random number and sends said first code to said remote device; and
a second processor, coupled to said random number generator, said second processor generating a second code based on at least said random number.
wherein said remote device is activated when said first code corresponds to said second code according to a second manner.

2. A remote control system according to claim 1, wherein said first processor generates said first code further based on said first data, and said second processor generates said second code further based on said second data.

3. A remote control system according to claim 1, wherein said mobile unit further comprises a first memory for storing said first data, and said remote device further comprises a second memory for storing said second data.

4. A remote control system according to claim 1, wherein said first processor further comprises a first variable generator for generating a first variable, and said first processor generates said first code further based on said first variable.

5. A remote control system according to claim 4, wherein said second processor further comprises a second variable generator for generating a second variable, and said second processor generates said second code further based on said second variable.

6. A remote control system according to claim 5, wherein said first processor further comprises a first synchronization module, and said second processor further comprises a second synchronization module;
wherein a value of said first variable corresponds to a value of said second variable according to a third manner when said first synchronization module and said second synchronization module are synchronized.

7. A remote control system according to claim 1, wherein said first data comprises an International Mobile Equipment Identity (IMEI) code and/or an International Mobile Subscriber Identity (IMSI) code.

8. A remote control system according to claim 1, wherein a first frequency and a second frequency are predetermined by said mobile unit and said remote unit, and said mobile unit communicates with said remote device selectively using said first frequency or said second frequency.

9. A remote control system according to claim 1, wherein said remote device is electrically connected to a device, and said mobile unit sends a command to said remote device for controlling said device according to said command.

10. A mobile unit, for use in a remote control system, said remote control system comprising a remote device wireless-connected to said mobile unit, said remote device storing second data and a second code, said mobile unit comprising:
a first memory for storing first data; and
a first processor, coupled to said first memory, for generating a first code based on at least a random number when said first data correspond to said second data according to a first manner, and said mobile unit sending said first code to said remote device;
wherein said mobile unit activates said remote device when said first code corresponds to said second code according to a second manner.

11. A mobile unit according to claim 10, wherein said remote device comprises a random number generator and a second processor, said random number generator for providing a random number, said second processor for generating said second code based on at least said random number.

12. A mobile unit according to claim 11, wherein said second processor generates said second code further based on said second data.

13. A mobile unit according to claim 10, wherein said first processor generates said first code further based on said first data.

14. A mobile unit according to claim 10, further comprising a first variable generator for generating a first variable, and said first processor generates said first code further based on said first variable.

15. A mobile unit according to claim 14, further comprising a second variable generator for generating a second variable, and said second processor generates said second code further based on said second variable.

16. A mobile unit according to claim 15, further comprising a first synchronization module connected to said first variable generator,
wherein said remote device further comprises a second synchronization module, and a value of said first variable corresponds to a value of said second variable according to a third manner when said first synchronization module and said second synchronization module are synchronized.

17. A remote control method for a remote control system, said remote control system comprising a mobile unit and a remote device, said mobile unit storing first data and said remote device storing second data, said method comprising:
(a) wireless-connecting said mobile unit and said remote device;
(b) sending said first data to said remote device;
(c) comparing said first data with said second data;
(d) generating and sending, by said remote device, a random number to said mobile unit when said first data correspond to said second data according to a first manner;
(e) generating, by said mobile unit, a first code based on said random number and sending said first code to said remote device, said remote device generating a second code based on said random number;
(f) comparing said second code with said first code; and
(g) activating said remote device when said first code corresponds to said second code according to a second manner.

18. A method according to claim 17, wherein the step (e) further comprises:
generating said first code further based on said first data and generating said second code further based on said second data.

19. A method according to claim 17, wherein the step (d) further comprises:
(d1) generating a first variable by said mobile unit, and generating a second variable by said remote device;
wherein the step (e) further comprises:
(e1) generating said first code further based on said first variable; and
(e2) generating said second code further based on said second variable.

20. A method according to claim 19, wherein the step (d) further comprises:
(d2) synchronizing said mobile unit with said remote device so that a value of said first variable corresponds to a value of said second variable according to a third manner.
